(19) United States
(12) Patent Application Publication
(10) Pub. No.: US 2012/0179717 A1
(43) Pub. Date: Jul. 12, 2012

(54) System and method for effectively providing entertainment recommendations to device users

(75) Inventors: Sean Kennedy, San Diego, CA (US); Fredrik Carpio, Menifee, CA (US); Rommel Garay, San Marco, CA (US); Adrian Crisan, San Diego, CA (US); Gary Lyons, San Diego, CA (US); Edward Winter, San Diego, CA (US)

(73) Assignee: Sony Corporation

(21) Appl. No.: 12/930,591

(22) Filed: Jan. 11, 2011

(51) Int. Cl. G06F 17/30

(52) U.S. Cl. 707/772; 707/758; 707/E17.066

(57) ABSTRACT

An electronic device that provides entertainment recommendations to a device user includes a metadata manager that automatically searches social networking websites on the Internet to obtain metadata pertaining to entertainment preferences of the device user of the electronic device. The metadata manager then compiles the metadata into a metadata database. A recommendation manager may then analyze the various metadata in the metadata database to automatically provide targeted entertainment recommendations to the device user through the electronic device.

### BACKGROUND SECTION

1. Field of the Invention

This invention relates generally to techniques for utilizing electronic devices, and relates more particularly to a system and method for effectively providing entertainment recommendations to device users.

2. Description of the Background Art

Implementing effective methods for utilizing electronic devices is a significant consideration for designers and manufacturers of contemporary electronic devices. However, effectively implementing and utilizing electronic devices may create substantial challenges for devices designers. For example, enhanced demands for increased device functionality and performance may require more device processing power and require additional hardware resources. An increase in processing or hardware requirements may also result in a corresponding detrimental economic impact due to increased production costs and operational inefficiencies.

Furthermore, enhanced device capability to perform various advanced operations may provide additional benefits to a device user, but may also place increased demands on the control and management of various device components. For example, an enhanced electronic device that effectively evaluates entertainment options may benefit from an efficient implementation because of the large amount and complexity of the digital data involved.

Due to growing demands on device resources and substantially increasing data magnitudes, it is apparent that developing new techniques for implementing and utilizing electronic devices is a matter of concern for related electronic technologies. Therefore, for all the foregoing reasons, developing effective techniques for implementing and utilizing electronic devices remains a significant consideration for designers, manufacturers, and users of contemporary electronic devices.

### SUMMARY

In accordance with the present invention, a system and method are disclosed for effectively providing entertainment recommendations to device users. In one embodiment of the present invention, a device user initially utilizes a computer to launch appropriate recommendation software including, but not limited to, a recommendation manager and a metadata manager. The device user may also configure the software to provide entertainment suggestions/recommendations in accordance with the present invention. During the configuration procedure, the device user may provide relevant information such as their email addresses and social networking sites.

In response, the metadata manager accesses the Internet and searches the device user's social networking sites and contact history to find any relevant metadata pertaining to the device user. The metadata manager then utilizes the metadata (such as metadata tags) related to entertainment items that were associated with the device user to create a metadata database with commonality statistics listed by the number of observed instances in each metadata category.

In accordance with the present invention, the recommendation manager may then utilize the metadata from the metadata database to query the Internet and social networking sites to create a list of entertainment recommendations that are specifically targeted toward the device user. The recommendation manager displays the list of recommended entertainment options to the device user on the computer. In response, the device user may choose one or more options from the displayed recommendations.

Finally, the recommendation manager may link the device user to a website or event location corresponding to the selected recommendation. The recommendation manager may also provide appropriate ancillary information that is related to the chosen recommendation including, but not limited to, purchase prices, show times, ticket prices, and possible means of travel and related costs. For all the foregoing reasons, the present invention therefore provides an improved system and method for effectively providing entertainment recommendations to device users.

### BRIEF DESCRIPTION OF THE DRAWINGS

FIG. 1 is a block diagram of an electronic network, in accordance with one embodiment of the present invention;

FIG. 2 is a block diagram for one embodiment of the computer of FIG. 1, in accordance with the present invention;

FIG. 3 is a block diagram for one embodiment of the memory of FIG. 2, in accordance with the present invention;

FIG. 4 is a block diagram for a metadata database, in accordance with one embodiment of the present invention;

FIG. 5 is a diagram of an entertainment item, in accordance with one embodiment of the present invention;

FIG. 6 is a diagram of entertainment recommendations, in accordance with one embodiment of the present invention;

FIG. 7 is a flowchart of method steps for performing an entertainment recommendation procedure, in accordance with one embodiment of the present invention; and

FIG. 8 is a flowchart of method steps for performing a metadata analysis procedure, in-accordance with one embodiment of the present invention.

### DETAILED DESCRIPTION

The present invention relates to improvements in utilizing electronic devices. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

In accordance with the present invention, an electronic device that provides entertainment recommendations to a device user includes a metadata manager that automatically searches social networking websites on the Internet to obtain metadata pertaining to entertainment preferences of the device user. The metadata manager then compiles the metadata into a metadata database. A recommendation manager may then analyze the various metadata that is stored in the metadata database to automatically provide targeted entertainment recommendations to the device user through the electronic device.

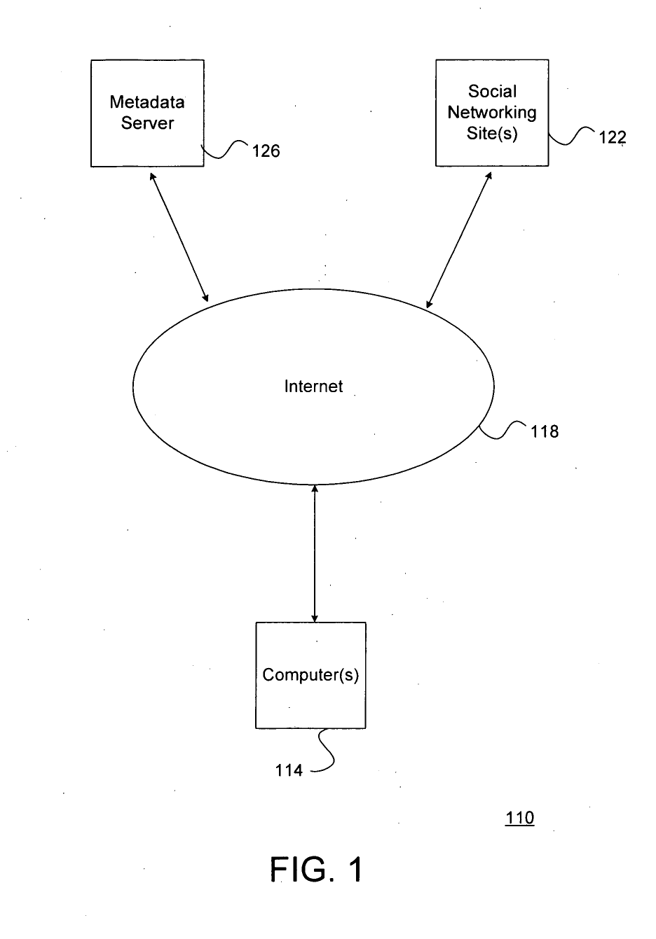

Referring now to FIG. 1, a block diagram of an electronic network 110 is shown, in accordance with one embodiment of the present invention. In the FIG. 1 embodiment, electronic network 110 may include, but is not limited to, at least one computer 114, the Internet 118, one or more social networking sites 122, and an optional metadata server 126. In alternate embodiments, electronic network 110 may be implemented using various components and configurations in addition to, or instead of, certain of those components and configurations discussed in conjunction with the FIG. 1 embodiment. For example, the Internet 118 may be implemented as any effective electronic network that includes any appropriate types of electronic devices.

In the FIG. 1 embodiment, computer 114 may be implemented as any electronic device that is configured to support and manage various functionalities for a device user. In the FIG. 1 embodiment, computer(s) 114 may participate in bi-directional communications with entities on the Internet 118 by utilizing any effective communication techniques. In the FIG. 1 embodiment, social networking sites 122 may include any known or enhanced websites for allowing social interaction between devices users of computers 114. One example of such a current existing social networking site is known as Facebook. In accordance with the present invention, social networking sites 122 may maintain extensive databases of device users' information, such as device users' interests and preferences with regard to entertainment choices. In certain embodiments, network 110 may include one or more metadata servers 126.

The present invention advantageously collects and utilizes various types of information from entities on the Internet 118 to provide appropriate targeted recommendations to device users. As personal computer usage moves increasingly into various aspects of social networking, the device users will, by their every day usage, create a trail of metadata regarding interests such as media and music preferences. The present invention proposes a software package that goes out to the Internet “Cloud” to search a user's social networking sites and contact history. The software finds all the metadata available regarding the movies, streamed video, streamed music, and shared content that the device user has run.

The software may then provides various capabilities based upon analysis of the gathered metadata. For example, the software may determine “show dates” of various entertainment events based on user's tastes. More specifically, the software may collect and analyze metadata of previously viewed sites, songs streamed, movies streamed, movies purchased, and songs purchased by a particular device user. The software may then base recommendations or suggestions on metadata specific to the device user or specific to a corresponding group of friends. The software may suggest show dates for movies or concerts, suggest travel dates for the device user or friends, provide musical news related to music, or provide movie news related to commonly viewed movies.

In one exemplary situation, over the course of the last three months a device user has purchased one DVD of a James Taylor concert, and has purchased five James Taylor music CD's. The software may then conduct an automated search of locations for James Taylor concerts that are within traveling distance. The software may bring up related information such as show times, ticket prices, and possible means of travel and costs of said travel.

In another exemplary situation, over the course of the last three months, the user has purchased six science-fiction movie DVDs, shared ten science-fiction book titles with friends, and downloaded every episode of the new “Battlestar Galactica” TV show. The software may then perform an automated search of upcoming science fiction movies within traveling distance. The software may provide appropriate related information such as show times, ticket prices, and possible means of travel and costs of said travel.

In another related capability based upon the analysis of metadata, the software may insert suggestions or recommendations into live chat sessions between device users of respective computers 114. For example, the software may analyze current or recent words and phrases from chat sessions as compared to popular items from the gathered metadata to automatically provide appropriate recommendations and other information to the device users. In certain embodiments, the software may correlate the metadata and recent chat topics such as geographic location(s), travel, eating habits, purchases, activities, source of messages, message topics, etc.

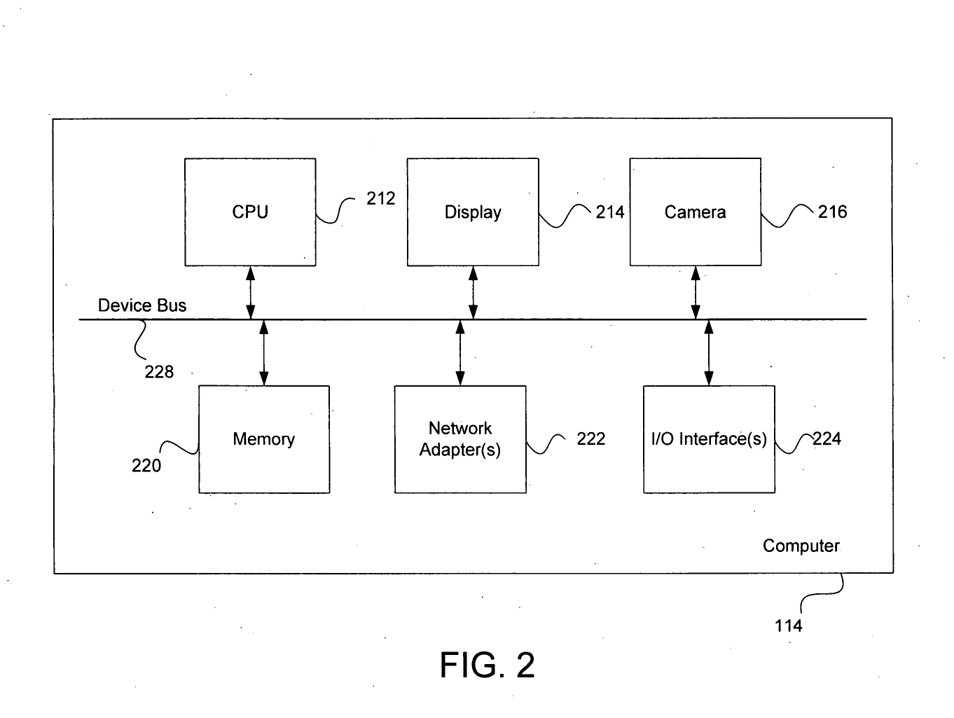

The software may then insert an appropriate suggestion or advertisement into the chat session. For example, a message might be “We noticed you recently purchased a Sony Bluray Player and Avatar on Bluray. Would you also like to purchase these similar films?” In certain embodiments, device users may be allowed to affirmatively block such suggestions. Additional details regarding the implementation and utilization of the FIG. 1 computer 114 are further discussed below in conjunction with FIGS. 2-8.

Referring now to FIG. 2, a block diagram for one embodiment of the FIG. 1 computer 114 is shown, in accordance with the present invention. In the FIG. 2 embodiment, computer 114 may include, but is not limited to, a central processing unit (CPU) 212, a display 214, a camera 216, a memory 220, one or more wireless or hard-wired network adapters 222, and input/output interfaces (I/O interfaces) 224. Certain of the foregoing components of computer 114 may be coupled to, and communicate through, a device bus 228.

In alternate embodiments, computer 114 may be implemented using components and configurations in addition to, or instead of, those certain of those components and configurations discussed in conjunction with the FIG. 2 embodiment. Furthermore, computer 114 may alternately be implemented as any other desired type of electronic device or entity. For example, computer 114 may include a cellular telephone, a personal digital assistant (PDA), a consumer electronics device, or any other type of smart electronic device.

In the FIG. 2 embodiment, CPU 212 may be implemented to include any appropriate and compatible microprocessor device that preferably executes software instructions to thereby control and manage the operation of computer 114. In the FIG. 2 embodiment, display 214 may include any effective type of display technology including a cathode-ray-tube monitor or a liquid-crystal display device with an appropriate screen for displaying various information to a device user.

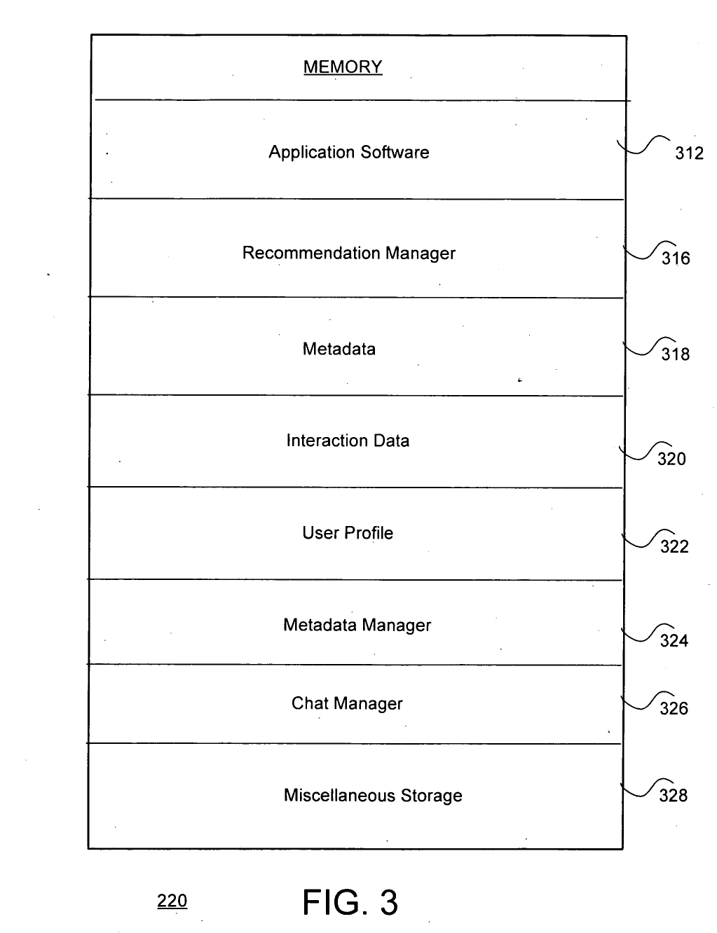

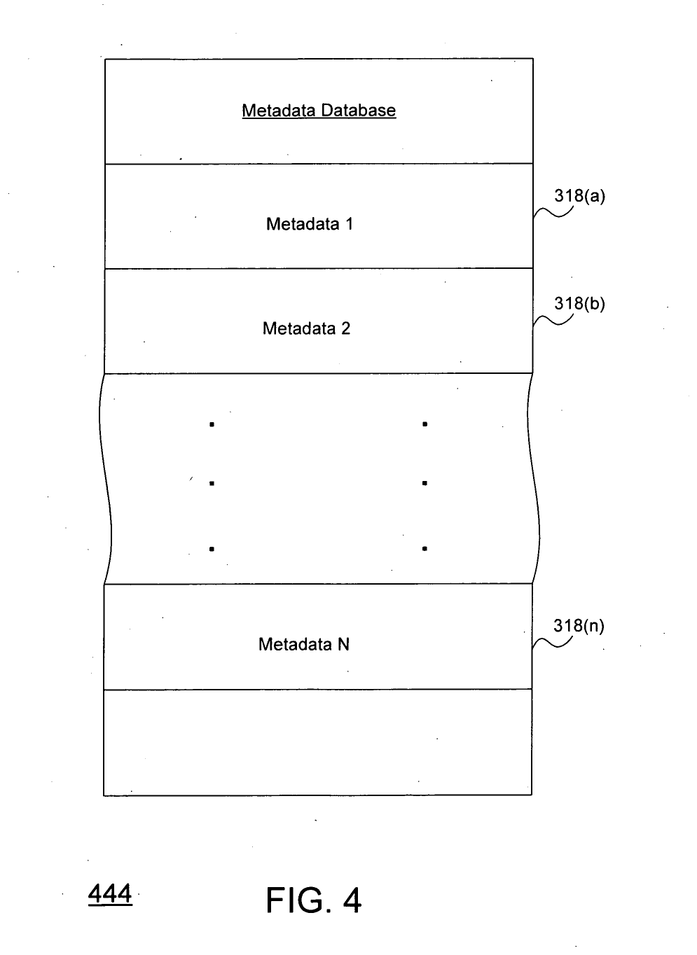

In the FIG. 2 embodiment, memory 220 may be implemented to include any combination of desired storage devices, including, but not limited to, read-only memory (ROM), random-access memory (RAM), and various types of non-volatile memory, such as floppy disks or hard disks. The contents and functionality of memory 220 are further discussed below in conjunction with FIGS. 3 and 4. In the FIG. 2 embodiment, I/O interfaces 224 may include one or more input and/or output interfaces to receive and/or transmit any required types of information for computer 114. For example, a device user may utilize I/O interfaces 224 to communicate with computer 114 by utilizing any appropriate and effective techniques. Additional details regarding the implementation and utilization of the FIG. 2 computer 114 are further discussed below in conjunction with FIGS. 3-8.

Referring now to FIG. 3, a block diagram for one embodiment of the FIG. 2 memory 220 is shown, in accordance with the present invention. In the FIG. 3 embodiment, memory 220 includes, but is not limited to, application software 312, a recommendation manager 316, metadata 318, interaction data 320, a user profile 322, a metadata manager 324, a chat manager 326, and miscellaneous storage 328. In alternate embodiments, memory 220 may include various components and functionalities in addition to, or instead of, certain of those components and functionalities discussed in conjunction with the FIG. 3 embodiment.

In the FIG. 3 embodiment, application software 312 may include program instructions that are preferably executed by CPU 212 (FIG. 2) to perform various functions and operations for computer 114. The particular nature and functionality of application software 312 preferably varies depending upon factors such as the specific type and particular functionality of the corresponding computer 114. In the FIG. 3 embodiment, an operating system (not shown) preferably controls and coordinates low-level functionality of computer 114.

In the FIG. 3 embodiment, computer 114 may utilize recommendation manager 316 to perform any of the functions for analyzing metadata 318, interaction data 320, and user profile 322 to provide appropriate recommendations to device users, as discussed above in conjunction with FIG. 1. In certain embodiments, any of recommendation manager 316, metadata 318, interaction data 320, user profile 322, and metadata manager 324 may alternately reside on a central metadata server 126 (FIG. 1).

In the FIG. 3 embodiment, interaction data 320 may include any appropriate information about interactions of the device user or computer 114. For example, interaction data 320 may include Internet browsing histories and commercial transactions of the device user. In the FIG. 3 embodiment, user profile 322 may include any desired information pertaining to a particular device user. For example, user profile 322 may include various types of personal information, user preferences, and demographic information pertaining to the device user.

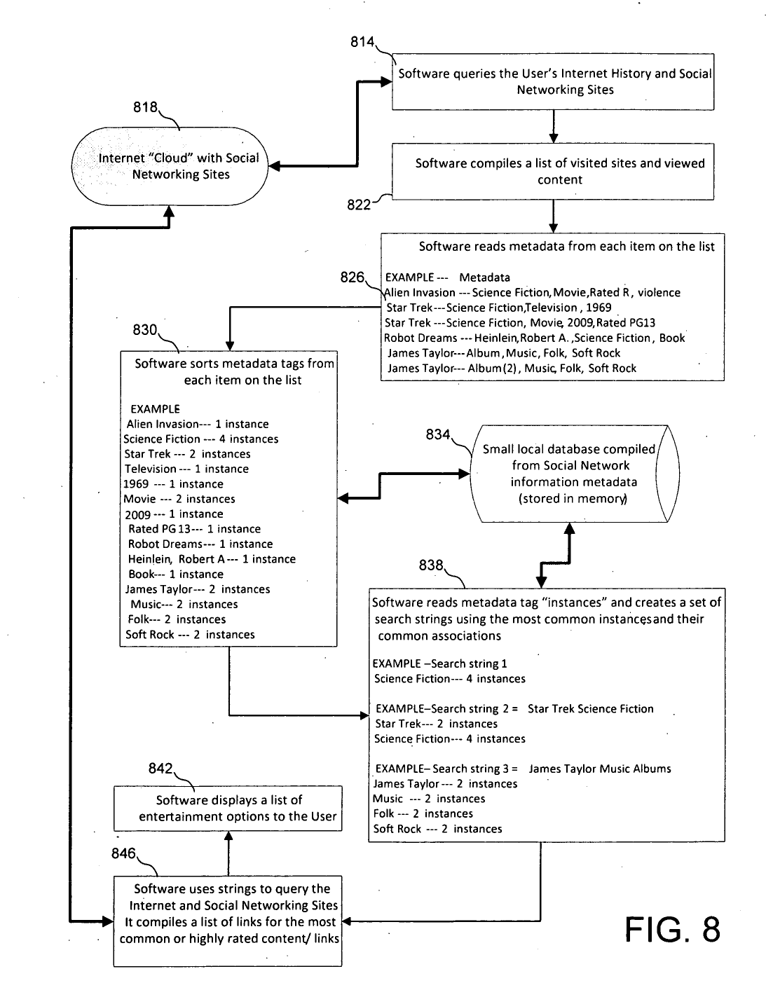

In the FIG. 3 embodiment, computer 114 may utilize metadata manager 324 to compile appropriate metadata, as further discussed below in conjunction with FIGS. 4 and 8. In the FIG. 3 embodiment, computer 114 may utilize chat manager 326 to conduct chat sessions on behalf of the device user. In the FIG. 3 embodiment, miscellaneous storage 326 may include any other information required by computer 114. Additional details regarding implementation and utilization of device memory 220 are further discussed below in conjunction with FIGS. 4 through 8.

Referring now to FIG. 4, a block diagram for a metadata database 444 is shown, in accordance with one embodiment of the present invention. In alternate embodiments, metadata databases 444 may be implemented using components and configurations in addition to, or instead of, certain of those components and configurations discussed in conjunction with the FIG. 4 embodiment.

In the FIG. 4 embodiment, metadata manager 324 (FIG. 3) or other appropriate entity may utilize the collected metadata 318 (FIG. 3) to populate metadata database 444. In the FIG. 4 embodiment, metadata database 444 30 may alternately reside on computer 114 or a central metadata server 126 (FIG. 1). In the FIG. 4 embodiment, metadata database 444 includes a series of different categories of metadata. In particular, the FIG. 4 example, includes metadata 1 (318(a)) through metadata N (381(n)). Any desired number of different metadata categories may be utilized.

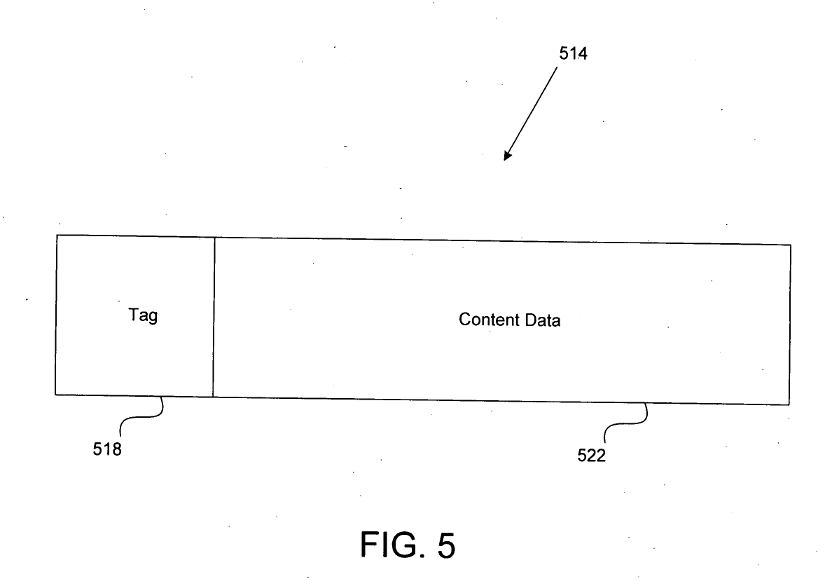

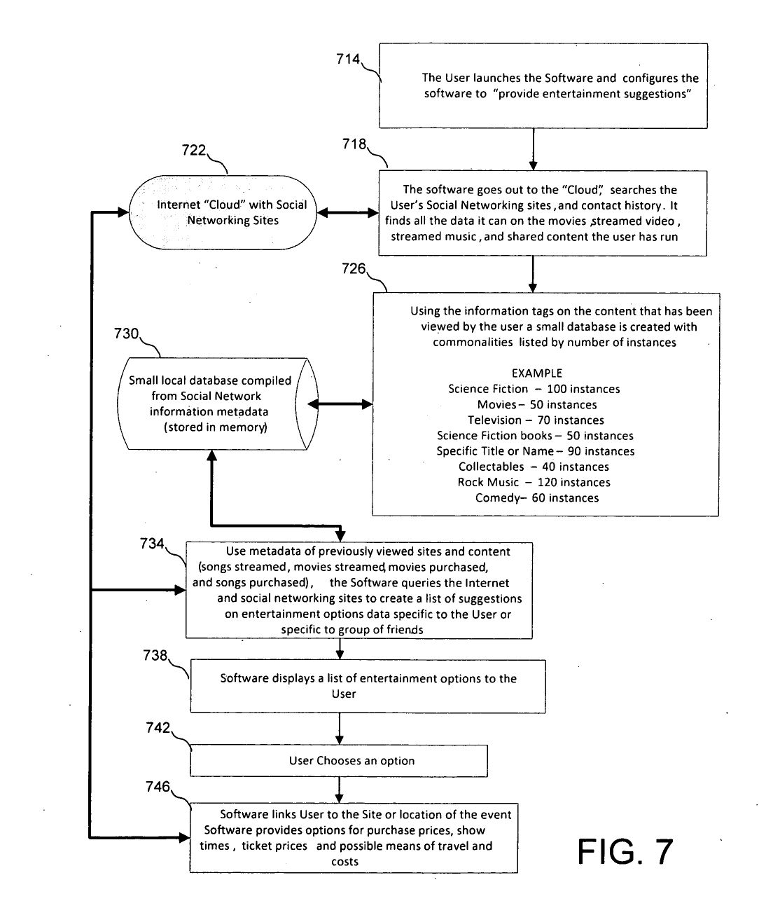

Each set of metadata 318 may include any desired type of information or data. For example, metadata database 444 may store metadata categories that include, but are not limited to, entertainment types, genres, names, titles, ratings, subject matter, etc. In certain embodiments, metadata manager 324 may obtain certain of the metadata from metadata tags that are attached to corresponding entertainment items, as discussed below in conjunction with FIG. 5. Additional details regarding implementation and utilization of the metadata database 444 are further discussed below in conjunction with FIGS. 7 and 8.

Referring now to FIG. 5, a diagram of an entertainment item 514 is shown, in accordance with one embodiment of the present invention. The FIG. 5 example is presented for purposes of illustration, and in alternate embodiments, entertainment items 514 may be implemented with configurations and components other than certain of those configurations and components discussed in conjunction with the FIG. 5 embodiment.

In the FIG. 5 embodiment, entertainment item 514 includes content data 522 and a metadata tag 518. In the FIG. 5 embodiment, metadata tag 518 may include any relevant information corresponding to entertainment item 514. For example, metadata tag 518 may include, but is not limited to, an entertainment type, a genre, proper names, a title, ratings, subject matter, etc. In certain embodiments of the present invention, the information in metadata tag 518 may be utilized to create a metadata database 444 (FIG. 4). For example, individual instances of each given tag 518 may be recorded in the metadata database 444 as metadata statistics for accurately generating targeted recommendations to device users. Additional details regarding utilization of metadata tags 518 are further discussed below in conjunction with FIGS. 7 and 8.

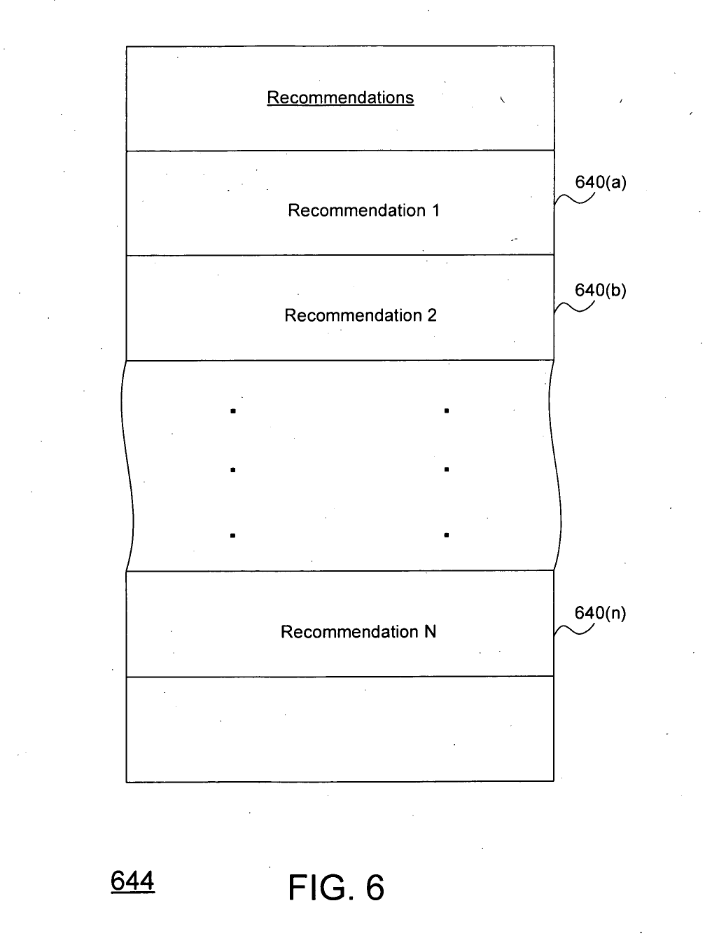

Referring now to FIG. 6, a block diagram of entertainment recommendations 644 is shown, in accordance with one embodiment of the present invention. In alternate embodiments, the present invention may create and utilize entertainment recommendations 644 with components and configurations in addition to, or instead of, certain of those components and configurations discussed in conjunction with the FIG. 6 embodiment.

In the FIG. 6 embodiment, a series of recommendations from an entertainment recommendation procedure are shown. In particular, FIG. 6 shows a recommendation 1 (640(a)) through a recommendation N 640(n). In alternate embodiments, any appropriate number of recommendations 640 are possible. In the FIG. 6 embodiment, recommendation manager 316 (FIG. 6) may select recommendations 640 by analyzing metadata 318 in a metadata database 444 (FIG. 4) according any selection criteria. For example, recommendations 640 may correspond to the most-frequently observed instances in various metadata categories.

In addition, recommendations 640 may be displayed on a computer 114 for viewing by a device user. Recommendations 640 may include any desired types of information including, but not limited to, advertisements, entertainment events, and various types of event-related information. Furthermore, recommendation 640 may not be restricted only to entertainment-related information. On the contrary, the techniques of the present invention may be applied similarly to recommend any other type of information to device users. Additional details regarding the creation of entertainment recommendations 644 are further discussed below in conjunction with FIGS. 7 and 8.

Referring now to FIG. 7, a flowchart of method steps for performing an entertainment recommendation procedure is shown, in accordance with one embodiment of the present invention. The FIG. 7 example is presented for purposes of illustration, and in alternate embodiments, the present invention may utilize steps and sequences other than certain of those steps and sequences discussed in conjunction with the FIG. 7 embodiment.

In block 714 of the FIG. 7 embodiment, a device user initially utilizes a computer 314 to launch appropriate recommendation software including, but not limited to, a recommendation manager 316 and a metadata manager 324. The device user may also configure the software to provide entertainment suggestions/recommendations in accordance with the present invention. During the configuration procedure, the device user may provide relevant information such as their email addresses and social networking sites. In block 718, the metadata manager 324 accesses the Internet 118 and searches the device user's social networking sites 122 and contact history to find any relevant metadata 318 pertaining to the device user.

In blocks 726 and 730, the metadata manager 324 utilizes metadata 318 (such as metadata tags 518) associated with entertainment items 514 that were viewed by the device user to create a metadata database 444 with commonality statistics listed by the number of observed instances of each metadata category. For purposes of illustration, block 726 of FIG. 7 provides several examples of the metadata categories and corresponding observed instances.

In block 734, the recommendation manager 316 utilizes the metadata 318 from the metadata database 444 to query the Internet 118 and social networking sites 122 to create a list of suggestions/recommendations 644 that are targeted specifically toward the device user or a group of friends. In block 738, the recommendation manager 316 displays the list of recommended entertainment options 644 to the device user. In block 742, the device user may then choose one or more options from the recommendations 644.

Finally, in block 746, the recommendation manager 316 may link the device user to an appropriate website or event location corresponding to the selected recommendation(s). The recommendation manager 316 may also provide ancillary information that is related to the chosen recommendation 644 including, but not limited to, purchase prices, show times, ticket prices, and possible means of travel and related costs. The FIG. 7 procedure may then terminate.

In certain embodiments, the FIG. 7 recommendation process may occur during a chat session between various device users of respective computers 114. In such an environment, the recommendation manager 316 may parse words and phrases from the chat sessions to obtain relevant search terms for matching with metadata in the metadata database 444. In certain embodiments, the recommendation manager 316 may also provide the recommendations 644 to selected contacts or friends of the device user in the event that any of these contacts or friends might wish to select/purchase one or more of the recommendation 644 for the device user. For all of the foregoing reasons, the present invention therefore provide an improved system and method for effectively providing entertainment suggestions to device users.

Referring now to FIG. 8, a flowchart of method steps for performing a metadata analysis procedure is shown, in accordance with one embodiment of the present invention. The FIG. 8 example is presented for purposes of illustration, and in alternate embodiments, the present invention may utilize steps and sequences other than certain of those steps and sequences discussed in conjunction with the FIG. 8 embodiment. In certain embodiments of the present invention, the FIG. 8 process may correspond to the foregoing steps 718, 726, 730, 734, and 738 of FIG. 7.

In block 814 of the FIG. 8 embodiment, a metadata manager 324 may query a device user's Internet history and social networking sites 122. In block 822, the metadata manager 324 compiles a contact list of visited websites, viewed content, and other information obtained from the query results. In block 826, the metadata manager 324 reads metadata 318 from each list item on the contact list. For purposes of illustration, block 826 of FIG. 8 provides several examples of contact list items and corresponding observed metadata 318.

In block 830, the metadata manager 324 sorts metadata tags 518 from each item on the contact list according to the number of respective observed instances. For purposes of illustration, block 830 of FIG. 8 provides several examples of the contact list items and corresponding observed instances. In block 834, the metadata manager 324 utilizes metadata 318 (including observed instances for each contact list item) to create a metadata database 444 with commonality statistics listed by the number of observed instances of each metadata category.

In block 838, a recommendation manager 316 reads the more frequently-observed metadata tag instances, and creates corresponding search strings. For purposes of illustration, block 838 of FIG. 8 provides several examples of search strings and corresponding observed instances. In block 846, the recommendation manager 316 utilizes the search strings to query the Internet 118 and social networking sites 122 to compile a list of recommendations 644 corresponding to the most common or highly-rated entertainment items 514 or links. Finally, in step 842, the recommendation manager 316 displays the list of recommended entertainment options 644 to the device user. The FIG. 8 procedure may then terminate.

The present invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

1. An electronic device that provides recommendations to a device user, comprising:
a metadata manager of said electronic device that searches an electronic network to obtain metadata pertaining to said device user of said electronic device;
a recommendation manager of said electronic device that analyzes said metadata to provide said recommendations to said device user through said electronic device; and
a processor of said electronic device that controls said metadata manager and said recommendation manager.

2. The electronic device of claim 1 wherein said recommendations relate to entertainment options that are available to said device user.

3. The electronic device of claim 1 wherein said metadata includes device user information obtained from a social networking website that is utilized by said device user.

4. The electronic device of claim 1 wherein said electronic device is a personal computer device.

5. The electronic device of claim 1 wherein said electronic network includes the Internet.

6. The electronic device of claim 1 wherein said metadata manager and said recommendation manager operate automatically to perform their respective functionalities.

7. The electronic device of claim 1 wherein said metadata manager and said recommendation manager provide said recommendations during a chat session by comparing chat dialogue with said metadata.

8. The electronic device of claim 1 wherein said recommendation manager provides said recommendations to other contacts of said device user through said electronic network.

9. The electronic device of claim 1 wherein said metadata includes user information derived from metadata tags associated with entertainment items previously selected by said device user.

10. The electronic device of claim 1 wherein said metadata manager compiles said metadata into a metadata database for access by said recommendation manager.

11. The electronic device of claim 10 wherein said metadata database is stored on a central metadata server connected to said electronic network.

12. The electronic device of claim 1 wherein said device user utilizes said electronic device to provide user email addresses and social networking websites to said metadata manager.

13. The electronic device of claim 12 wherein said metadata manager queries said electronic network to obtain said metadata regarding an Internet history and social networking information for said device user.

14. The electronic device of claim 13 wherein said metadata manager analyzes metadata tags from said metadata to generate instance statistics for corresponding metadata categories.

15. The electronic device of claim 14 wherein said metadata manager stores said instance statistics and said metadata into a metadata database.

16. The electronic device of claim 15 wherein said recommendation manager utilizes said metadata database to generate search strings that are transmitted across said electronic network to identify said recommendations.

17. The electronic device of claim 16 wherein said recommendation manager creates a list of said recommendations based upon search results of said search strings from said electronic network.

18. The electronic device of claim 17 wherein said recommendation manager displays said recommendations upon said electronic device for selecting by said device user.

19. The electronic device of claim 18 wherein said recommendation manager displays relevant information on said electronic device related to a selected one of said recommendations.

20. A method for providing recommendations to a device user of an electronic device, comprising:
utilizing a metadata manager of said electronic device for searching an electronic network to obtain metadata pertaining to said device user of said electronic device;
analyzing said metadata with a recommendation manager of said electronic device to provide said recommendations to said device user through said electronic device; and
controlling said metadata manager and said recommendation manager with a processor of said electronic device.
